(19) United States
(12) Patent Application Publication
(10) Pub. No.: US 2008/0165211 A1
(43) Pub. Date: Jul. 10, 2008

(54) Method for Driving Plasma Display Panel and Plasma Display Apparatus

(76) Inventors: Hidehiko Shoji, Osaka (JP); Takahiko Origuchi, Osaka (JP); Mitsuo Ueda, Hyogo (JP); Yutaka Yoshihama, Osaka (JP); Shigeo Kigo, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/795,306

(22) PCT Filed: Dec. 12, 2006
(86) PCT No.: PCT/JP2006/024748

§ 371 Date: Jul. 16, 2007

(30) Foreign Application Priority Data
Dec. 13, 2005 (JP) 2005-358735
Dec. 13, 2005 (JP) 2005-358736

(51) Int. Cl. G09G 3/18

(52) U.S. Cl. 345/690

(57) ABSTRACT

A method for driving a plasma display panel is provided, wherein one field period is structured of a plurality of subfields having a write period for generating write discharges selectively in the discharge cells, and a sustain period for generating the number of times of sustain discharges according to brightness levels in the discharge cells which have generated the write discharges, and in the sustain period, after voltage to generate the last sustain discharge is applied to the display electrode pairs, at time intervals according to the lighting rate of the discharge cells in the subfield, voltage to ease the voltage difference between the electrodes of the display electrode pairs is applied to the display electrode pairs. According to such a structure, it is possible to generate stable write discharges, without increasing voltage necessary for generating the write discharges, even with a large size and high brightness panel.

### TECHNICAL FIELD

The present invention relates to a method for driving a plasma display panel and a plasma display apparatus.

### BACKGROUND ART

In an AC surface discharge type panel typical as a plasma display panel (hereinafter referred to simply as “panel”), many discharge cells are formed between a front plate and a back plate arranged to oppose one another. In the front plate, a plurality of pairs of display electrodes each including a pair of scan electrodes and a sustain electrode are formed in parallel with one another on a front glass substrate, and a dielectric layer and a protection layer are so formed as to cover those display electrode pairs. In the back plate, a plurality of parallel data electrodes, and a dielectric layer so as to cover them, and further thereon a plurality of rib barriers in parallel with the data electrodes are formed respectively on a back glass substrate, and a phosphor layer is formed on the surface of the dielectric layer and the sides of the rib barriers. And, the front plate and the back plate are arranged to oppose one another and sealed so that the display electrode pairs and the data electrodes should cross solidly, and electric discharge gas containing xenon is filled in internal electric discharge space. Herein, discharge cells are formed in the portion where the display electrode pairs and the data electrodes oppose one another. In the panel of such a structure, ultraviolet rays are generated by gas discharge within each discharge cell, and by these ultraviolet rays, the phosphor of each color of RGB is excited to emit light and thereby the color display is performed.

As the method for driving the panel, the subfield method is generally used in which one field period is divided into a plurality of subfields, and by combinations of subfields to emit light, a gradation display is carried out. Each subfield has an initialization period, a write period, and a sustain period, and in the initialization period, it generates initialization discharge, and forms a wall electric charge required for following write operation on each electrode. In the write period, it generates a write discharge selectively in the discharge cells which should perform the display and forms a wall charge. And in the sustain period, it applies sustain pulse to the display electrode pairs consisting of scan electrodes and sustain electrodes alternately, and generates the sustain discharge in the discharge cells that have made the write discharge, and makes the phosphor layer of corresponding discharge cells emit light and thereby an image display is performed.

In the subfield method, a novel driving method is disclosed in which the initialization discharge is performed by use of a voltage waveform which changes moderately, and further the performed initialization discharge is performed selectively to those discharge cells which have performed the sustain discharge, and thereby light emissions not related to the gradation display are reduced as much as possible and the contrast ratio is improved (for example, refer to Patent Document 1).

In Patent Document 1, so-called thin width elimination discharge is also described in which the pulse width of the last sustain pulse in the sustain period is made shorter than the pulse width of other sustain pulses, and thereby the voltage difference due to the wall charge between the display electrodes is eased. By generating this thin width elimination discharge stably, a precise write operation can be performed in the write period of the following subfield, and a high plasma display apparatus of a high contrast ratio can be realized.

However, along with the recent large size and high brightness of the panels, there is a tendency that the thin width elimination discharge becomes unstable, and accordingly, the write discharge becomes unstable, and the write discharge does not occur in the discharge cells which should perform a display and the image display quality is degraded, or the voltage required in order to generate the write discharge is increased, and other problems occur.

[Patent Document 1] Japanese Unexamined Patent Publication No. 2000-242224

### DISCLOSURE OF THE INVENTION

The present invention has been made in consideration of these problem, and accordingly, an object of the present invention is to provide a method for driving a panel and a plasma display apparatus for generating stable write discharges for high image display quality, without increasing voltage necessary for generating the write discharges, even with a large size and high brightness panel.

In order to achieve the above object, according to one aspect of the present invention, there is provided a method for driving a panel equipped with a plurality of discharge cells having display electrode pairs including scan electrodes and sustain electrodes, wherein one field period is structured of a plurality of subfields having a write period for generating write discharges selectively in the discharge cells, and a sustain period for generating the number of times of sustain discharges according to brightness levels in the discharge cells which have generated the write discharges, and after voltage to generate the last sustain discharge in the sustain period is applied to the display electrode pairs, at time intervals according to the lighting rate of the discharge cells in the subfield, voltage to ease the voltage difference between the electrodes of the display electrode pairs.

### BRIEF DESCRIPTION OF THE DRAWINGS

FIG. 1 is an exploded perspective view showing the principal part of a panel used for a first embodiment according to the present invention.

FIG. 2 is a figure showing an electrode arrangement of the panel.

FIG. 3 is a circuit block diagram of a plasma display apparatus which uses the panel.

FIG. 4 is a figure showing drive voltage waveforms to be applied to respective electrodes of the panel.

FIG. 5 is a figure showing the relation among subfields and the lighting rates and elimination phase differences of in a first embodiment.

FIG. 6 is a circuit diagram of a sustain pulse generating unit of a plasma display apparatus in a first embodiment according to the present invention.

FIG. 7 is a timing chart for explaining the operation of the sustain pulse generating unit of a plasma display apparatus in a first embodiment according to the present invention.

FIG. 8A is a schematic figure showing the relation between write pulse voltage required to generate normal write discharges and elimination phase difference.

FIG. 8B is a schematic figure showing the relation between scan pulse voltage required to generate normal write discharges and elimination phase difference.

FIG. 8C is a schematic figure showing the relation between scan pulse voltage required for write discharges and the lighting rate.

FIG. 8D is a schematic figure showing the relation between scan pulse voltage required to generate normal write discharges and elimination phase difference and the lighting rate.

FIG. 9 is a figure showing the value of the scan pulse voltage at which a write failure of the second kind does not occur.

FIG. 10 is a figure showing the relation among subfields and the lighting rates and elimination phase differences in a second embodiment according to the present invention.

FIG. 11 is a figure showing the relation of the lighting rate and elimination phase difference in a second embodiment according to the present invention.

### EXPLANATION OF SYMBOLS

10 Panel
22 Scan electrode
23 Sustain electrode
32 Data electrode
51 Image signal processing circuit
52 Data electrode drive circuit
53 Scan electrode drive circuit
54 Sustain electrode drive circuit
55 Timing generation circuit
58 Lighting rate calculation circuit
100, 200 Sustain pulse generating unit
110, 10 Electric power collecting unit
120, 220 Clamp unit

### PREFERRED EMBODIMENTS FOR CARRYING OUT OF THE INVENTION

One aspect of the present invention is a method for driving a panel equipped with a plurality of discharge cells having display electrode pairs including scan electrodes and sustain electrodes, wherein one field period is structured of a plurality of subfields having a write period for generating write discharges selectively in the discharge cells, and a sustain period for generating the number of times of sustain discharges according to brightness levels in the discharge cells which have generated the write discharges, and after voltage to generate the last sustain discharge in the sustain period is applied to the display electrode pairs, at time intervals according to the lighting rate of the discharge cells in the subfield, voltage to ease the voltage difference between the electrodes of the display electrode pairs. According to this method, it is possible to provide a method for driving a panel and a plasma display apparatus for generating stable write discharges for high image display quality, without increasing voltage necessary for generating the write discharges, even with a large size and high brightness panel.

Further, in a method for driving a panel according to the present invention, it is preferable that at least one subfield that is so controlled that the time interval when the lighting rate of discharge cells is high should be longer the time interval when the lighting rate of discharge cells is low is included in one field period.

Furthermore, in a method for driving a panel according to the present invention, the time interval in the subfields whose brightness level is small may be so controlled as to become equal or shorter than the time interval in the subfields whose brightness level is large. According to this method, it is possible to further improve the display image quality.

Moreover, a plasma display apparatus according to the present invention includes a panel which is equipped with a plurality of discharge cells having a display electrode pair structured of a scan electrodes and a sustain electrode, and a drive circuit which drives the panel, wherein the drive circuit structures one field period of a plurality of subfields having a write period for generating write discharges selectively in the discharge cells and a sustain period for generating the number of times of sustain discharges according to brightness levels in the discharge cells which have generated the write discharges, and is equipped with a first switching element which applies the voltage for generating the sustain discharge to the display electrode pair, and a second switching element which applies the voltage for easing the voltage difference between the electrodes of the display electrode pair to the display electrode pair, and in generating the last sustain discharge in the sustain period, turns on the first switching element, then after time intervals according to the lighting rate of the discharge cells in the subfield, turns on the second switching element. According to this method too, it is possible to provide a method for driving a panel and a plasma display apparatus for generating stable write discharges for high image display quality, without increasing voltage necessary for generating the write discharges, even with a large size and high brightness panel.

Still further, a plasma display apparatus according to the present invention is equipped with a lighting rate calculation circuit which computes the lighting rate of the discharge cells for each subfield on the basis of the image data for each subfield, and it is preferable that the drive circuit is so structured that at least one subfield that is so controlled that the time interval when the lighting rate of discharge cells is high should be longer the time interval when the lighting rate of discharge cells is low is included in one field period.

Furthermore, in a plasma display apparatus according to the present invention, the time interval in the subfields whose brightness level is small may be so controlled as to become equal to or shorter than the time interval in the subfields whose brightness level is large. According to this method, it is possible to further improve the display image quality.

Moreover, the time interval in a method for driving a panel according to the present invention may be switched on the basis of the comparison of the lighting rate of the discharge cells in the current subfield and a predetermined threshold value, and the threshold value at switching from a first time interval to a second time interval may be set larger than the threshold value at switching from the second time interval to the first time interval. According to this method, it is possible to stabilize the brightness of display images, and improve the image display quality.

Hereafter, the driving method of a panel in embodiments according to the present invention is explained with reference to attached drawings.

### First Embodiment

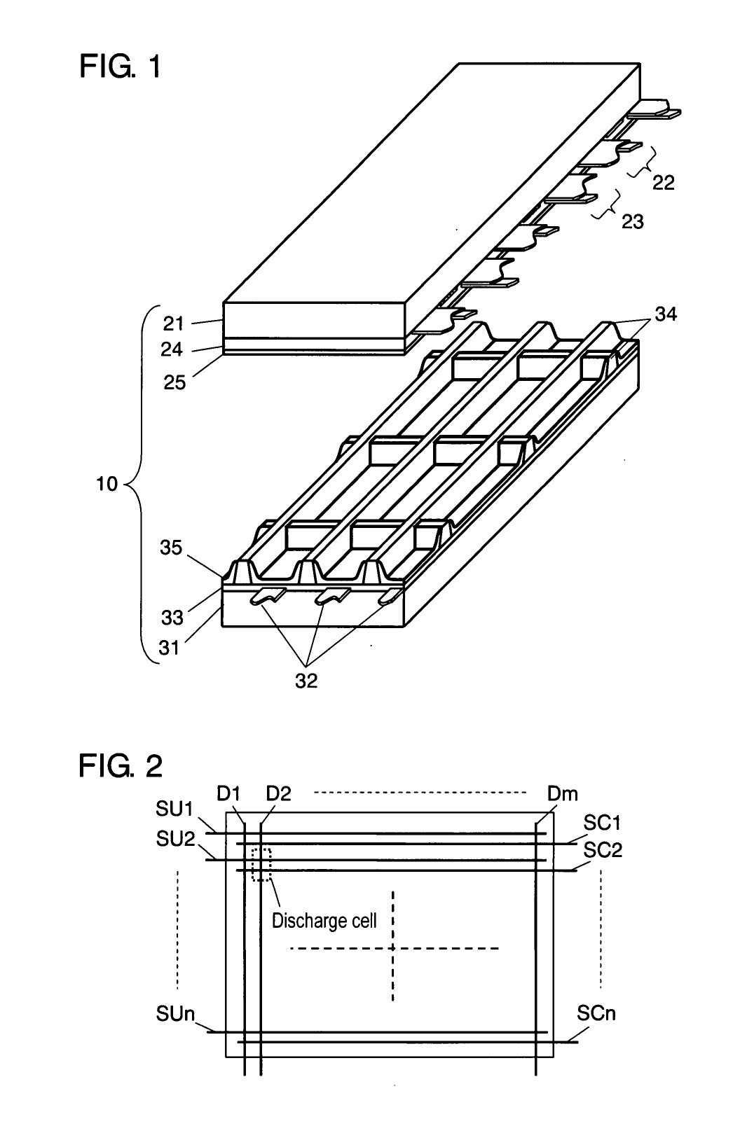

FIG. 1 is an exploded perspective view showing the principal part of a panel used for the first embodiment according to the present invention. Panel 10 is so structured that glass front substrate 21 and glass back substrate 31 are arranged to oppose one another, and discharge space are formed therebetween. On front plate 21, a plurality of scan electrodes 22 and sustain electrodes 23 which constitute the display electrode pairs are formed in parallel mutually. And dielectric layer 24 is formed so as to cover scan electrodes 22 and sustain electrodes 23, and protection layer 25 is formed on dielectric layer 24. Further, on back substrate 31, a plurality of data electrodes 32 covered with insulator layer 33 are formed, and on insulator layer 33, curb-shaped rib barriers 34 are formed. Moreover, phosphor layer 35 is formed on the surface of insulator layer 33 and the side surfaces of rib barriers 34. And, front substrate 21 and the back substrate 31 are arranged so as to oppose one another so that scan electrodes 22 and sustain electrodes 23 and data electrodes 32 should cross one another, and mixed gas of for example neon and xenon is filled in the electric discharge space formed therebetween as electric discharge gas. Meanwhile, the structure of the panel is not necessarily limited to the one mentioned above, but it may be for example one equipped with stripe-shaped rib barriers.

FIG. 2 is a figure showing an electrode arrangement of the panel used for the first embodiment according to the present invention. In the row direction, n pieces of scan electrodes SC1 to SCn (scan electrode 22 shown in FIG. 1) and n pieces of sustain electrodes SU1 to SUn (sustain electrode 23 shown in FIG. 1) are arranged, and in the column direction, m pieces of data electrodes D1 to Dm (data electrode 32 shown in FIG. 1) are arranged. And, in the portion where one pair of scan electrode SCi and sustain electrode SUi (i=1 to n) and one data electrode Dj (j=1 to m) intersect, a discharge cell is formed and m×n pieces of discharge cells are formed in the electric discharge space.

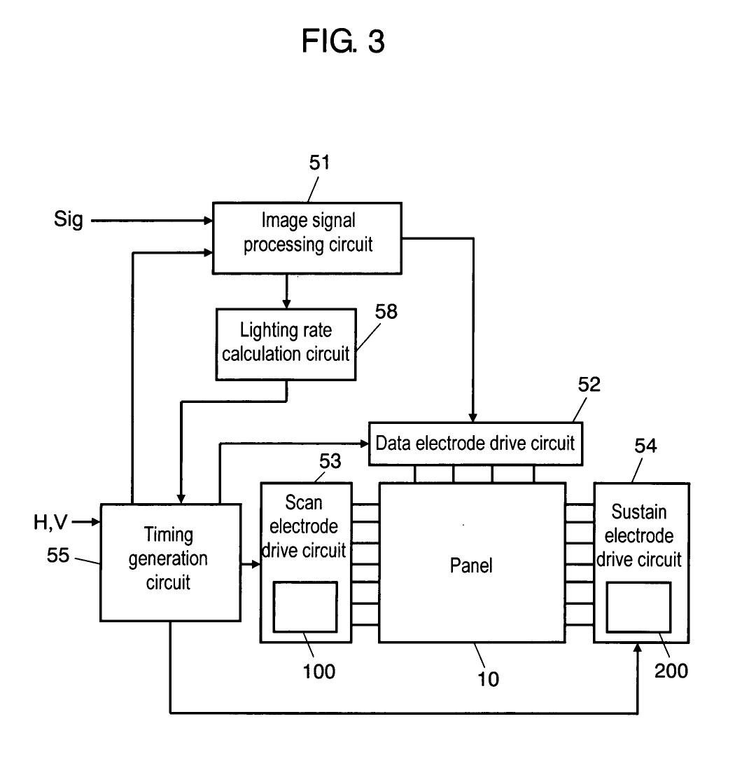

FIG. 3 is a circuit block diagram of a plasma display apparatus in the first embodiment according to the present invention. This plasma display apparatus is equipped with panel 10, image signal processing circuit 51, data electrode drive circuit 52, scan electrode drive circuit 53, sustain electrode drive circuit 54, timing generating circuit 55, lighting rate calculation circuit 58, and power supply circuit (not illustrated therein).

Image signal processing circuit 51 converts image signal Sig into the image data for each subfield. The data electrode drive circuit 52 converts image data into signals corresponding to data electrode D1 to Dm and drives respective data electrodes D1 to Dm. Lighting rate calculation circuit 58 computes the lighting rate of the discharge cell for each subfield, i.e., the rate of the number of discharge cells to be turned on to the number of the total discharge cells, on the basis of the image data for each subfield. Timing generator circuit 55 generates various kinds of timing signals on the basis of horizontal sync signal H, vertical sync signal V, and the lighting rate that calculation circuit 58 computes, and supplies them to respective circuit blocks. Scan electrode drive circuit 53 supplies drive voltage waveforms to scan electrodes SC1 to SCn on the basis of the timing signals, and sustain electrode drive circuit 54 supplies drive voltage waveforms to sustain electrodes SU1 to SUn on the basis of the timing signals. Herein, scan electrode drive circuit 53 is equipped with sustain pulse generating unit 100 for generating the sustain pulse to be mentioned later, sustain electrode drive circuit 54 is equipped with sustain pulse generating unit 200 similarly.

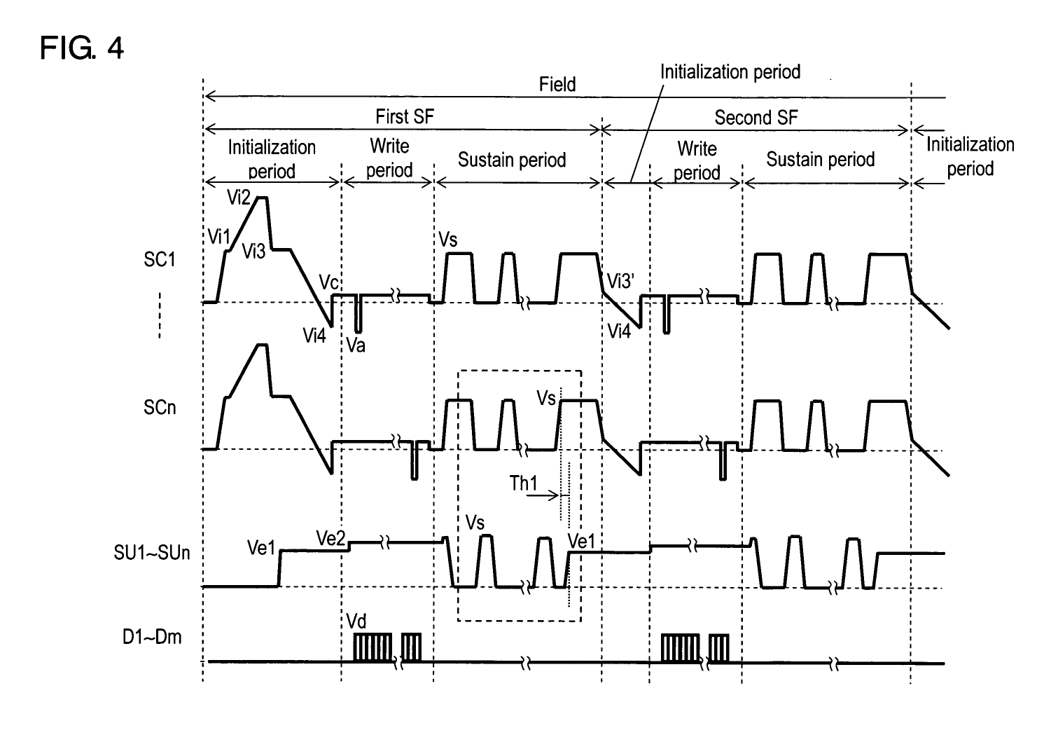

Next, the drive voltage waveforms for driving the panel and the operation thereof are explained. In the present embodiment, explanations are made on the assumption that one field is divided into 10 subfields (first SF, second SF, . . . , tenth SF), and each subfield has brightness levels (1, 2, 3, 6, 11, 18, 30, 44, 60, 81) respectively. FIG. 4 is a figure showing drive voltage waveforms to be applied to respective electrodes of the panel used for the first embodiment of the present invention, and one field is divided into a plurality of subfields, and each subfield has an initialization period, a write period, and a sustain period.

In the initialization period of the first SF, first in the first half thereof, data electrodes D1 to Dm and sustain electrodes SU1 to SUn are held at 0 V, and ramp voltage which goes up moderately from voltage Vi1 which becomes not more than the electric discharge starting voltage toward voltage V12 which exceeds the electric discharge starting voltage is applied to scan electrodes SC1 to SCn. Then, weak initialization discharge is made in all the discharge cells, and negative wall voltage is accumulated on scan electrodes SC1 to SCn, and positive wall voltage is accumulated on sustain electrodes SU1 to SUn and data electrodes D1 to Dm. Herein, the wall voltage on the electrodes refers to the voltage generated by the wall electric charge accumulated on the dielectric layer and the phosphor layer which cover the electrodes.

Then, in the second half of the initialization period, sustain electrodes SU1 to SUn are kept at positive voltage Ve1, and the ramp voltage which descends moderately from voltage Vi3 toward voltage Vi4 is applied to scan electrodes SC1 to SCn. Then weak initialization discharge occurs one again in all the discharge cells, and the wall voltage between scan electrodes SC1 to SCn and sustain electrodes SU1 to SUn is weaken, and the positive wall voltage on data electrodes D1 to Dm is adjusted to a value suitable for the write operation.

Thus, in the present embodiment, the initialization operation of the first SF is the all cell initialization operation where the initialization discharge is performed to all the discharge cells.

In the next write period, sustain electrodes SU1 to SUn are held at voltage Ve2, and scan electrodes SC1 to SCn are held at voltage Vc. Next, negative scanning pulse voltage Va is applied to scan electrode SC1 at the first line, and positive write pulse voltage Vd is applied to the data electrode Dk (k=1 to m) of the discharge cells which should be displayed on the first line of data electrodes D1 to Dm. At this moment, the voltage of the intersection portion of data electrode Dk and scan electrode SC1 becomes what the wall voltage on the data electrode Dk and the wall voltage on the scan electrode SC1 are added to externally applied voltage (Vd−Va), and exceeds the electric discharge starting voltage. And, write discharge occurs between data electrode Dk and scan electrode SC1 and between sustain electrode SU1 and scan electrode SC1, and positive wall voltage is accumulated on scan electrode SC1 of this discharge cell, and negative wall voltage is accumulated on sustain electrode SU1, and negative wall voltage is accumulated also on data electrode Dk. Thus, the write operation which performs the write discharge in the discharge cells which should be displayed on the first line, and accumulates wall voltage on the respective electrodes is performed. On the other hand, since the voltage at the intersection portion of data electrodes D1 to Dm and scan electrode SC1 to which the write pulse voltage Vd is not applied does not exceed the electric discharge starting voltage, the write discharge does not occur. The above write operation is performed one after another until it reaches the discharge cells at the n-th line, and then the write period ends.

In the next sustain period, driving is made by using an electric power recovery circuit in order to reduce the power consumption. The details of the drive voltage waveforms are described later, and herein the outline of the sustain operation in the sustain period is explained. First, positive sustain pulse voltage Vs is applied to scan electrodes SC1 to SCn, and grounding voltage, i.e., 0 V, is applied to sustain electrodes SU1 to SUn. Then, in the discharge cells which have made write electric discharge, the voltage between scan electrode SCi and sustain electrode SUi becomes what the wall voltage on scan electrode SCi and the wall voltage on sustain electrode SUi are added to sustain pulse voltage Vs, and exceeds the electric discharge starting voltage. And, sustain discharge takes place between scan electrode SCi and sustain electrode SUi, and phosphor layer 35 emits light by the ultraviolet rays generated at this moment. And negative wall voltage is accumulated on scan electrode SCi, and positive wall voltage is accumulated on sustain electrode SUi. Furthermore, positive wall voltage is accumulated also on data electrode Dk. In the discharge cells in which the write electric discharge has not occur in the write period, sustain discharge is not generated, but the wall voltage at the moment of the end of the initialization period is held.

Then, 0 V is applied to scan electrodes SC1 to SCn, and sustain pulse voltage Vs is applied to sustain electrodes SU1 to SUn respectively. Then, in the discharge cells which have caused sustain discharge, since the voltage between sustain electrode SUi and scan electrode SCi exceeds the electric discharge starting voltage, sustain discharge takes place between sustain electrode SUi and scan electrode SCi once again. Negative wall voltage is accumulated on sustain electrode SUi, and positive wall voltage is accumulated on scan electrode SCi. Thereafter in the same manners, the sustain pulse voltages of the number according to brightness levels are applied to scan electrodes SC1 to SCn and sustain electrodes SU1 to SUn alternately, and voltage differences are given between the electrodes of the display electrode pair, thereby the sustain discharge is continuously performed in the discharge cells which have made write discharge in the write period.

Thereafter, at the last of the sustain period, so-called a thin width pulse-shaped voltage difference is given to between the electrodes of scan electrodes SC1 to SCn and sustain electrodes SU1 to SUn, and while the positive wall electric charge on data electrode Dk is left, the wall voltage on scan electrode SCi and sustain electrode SUi is eliminated. In concrete, after sustain electrodes SU1 to SUn are made back to 0 V once, sustain pulse voltage Vs is applied to scan electrodes SC1 to SCn. Then, sustain discharge takes place between sustain electrode SUi and scan electrode SCi in the discharge cells which have caused sustain discharge. And before this electric discharge is completed, i.e., while the charged particles generated in the electric discharge remain enough in the electric discharge space, voltage Ve1 is applied to sustain electrodes SU1 to SUn. Thereby, the voltage difference between the electrodes of sustain electrode SUi and scan electrode SCi becomes weaker to the range of (Vs to Ve1). Then, the wall voltage between scan electrodes SC1 to SCn and sustain electrodes SU1 to SUn is weakened to the range of the difference (Vs to Ve1) of the voltages applied to the respective electrodes, with the positive wall electric charge left on the data electrode Dk. Hereinafter, this electric discharge is referred to as “elimination electric discharge”, and the voltage difference to be given between scan electrodes SC1 to SCn and sustain electrodes SU1 to SUn in order to generate the elimination electric discharge is a thin width pulse-shaped voltage difference.

Thus, after the last sustain discharge, i.e., after voltage Vs for generating elimination electric discharge is applied to scan electrodes SC1 to SCn, at predetermined time interval (hereinafter referred to as “elimination phase difference Th1”), voltage Ve1 for easing the voltage difference between the electrodes of the display electrode pair is applied to sustain electrodes SU1 to SUn. In the sustain period of the first SF, the elimination phase difference Th1 is so controlled as to become 150 ns, irrespective of the lighting rate. In this way, the sustain operation in the sustain period of the first SF is completed.

In the initialization period of the second SF, sustain electrode SU1 to SUn is held at voltage Ve1, data electrodes D1 to Dm is held at 0 V respectively, and the ramp voltage which descends moderately from voltage Vi3′ toward voltage Vi4 is applied to scan electrodes SC1 to SCn. Then, in the discharge cells which have performed sustain discharge in the sustain period of the subfield just before, weak initialization discharge occurs and the wall voltage on scan electrode SCi and sustain electrode SUi is weaken. Moreover, to the data electrode Dk, since positive wall voltage has been accumulated sufficiently on data electrode Dk in the last sustain period, the superfluous portion of this wall voltage is discharged, and it is adjusted to wall voltage suitable for the write operation. On the other hand, with regard to the discharge cells which have not performed sustain discharge in the previous subfield, discharge is not performed, and the wall electric charge at the moment of the end of the initialization period of the previous subfield is maintained as it is.

Thus, the initialization operation of the second SF is a selective initialization operation where initialization discharge is selectively performed to the discharge cells which have performed the sustain operation in the sustain period of the last subfield.

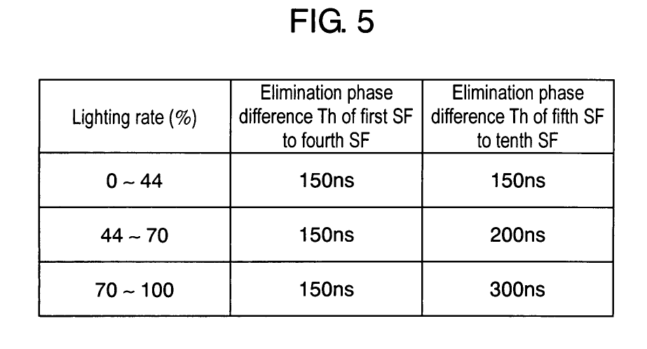

Since the operation of the write period of the second SF is same as that of the first SF, the explanation thereof is not given herein. The operation of the following sustain period is also same except for the number of sustain pulses. The operation of the initialization period in third SF to the tenth SF is same selective initialization operation as that of the second SF, and the write operation of the write period is same as that of the second SF. However, in the present embodiment, the elimination phase difference Th1 of the voltage applied to the respective display electrode pairs at the last of the sustain period is controlled by the subfields and the lighting rate thereof FIG. 5 is a figure showing the relation between the subfield and the lighting rate in the first embodiment of the present invention. As shown therein, the elimination phase difference Th1 is so controlled as to become 150 ns in the first SF to the fourth SF, irrespective of the lighting rate. Moreover, in the fifth SF to the tenth SF, when the lighting rate is less than 44%, the elimination phase difference Th1 is controlled to become 150 ns, and when the lighting rate is not less than 44% and less than 70%, the lighting rate is controlled to become 200 ns, and when the elimination phase difference Th1 is not more than 70%, the elimination phase difference Th1 is controlled to become 300 ns. Through the above control, it is possible to generate stable write discharge without increasing the scan pulse voltage and the data pulse voltage.

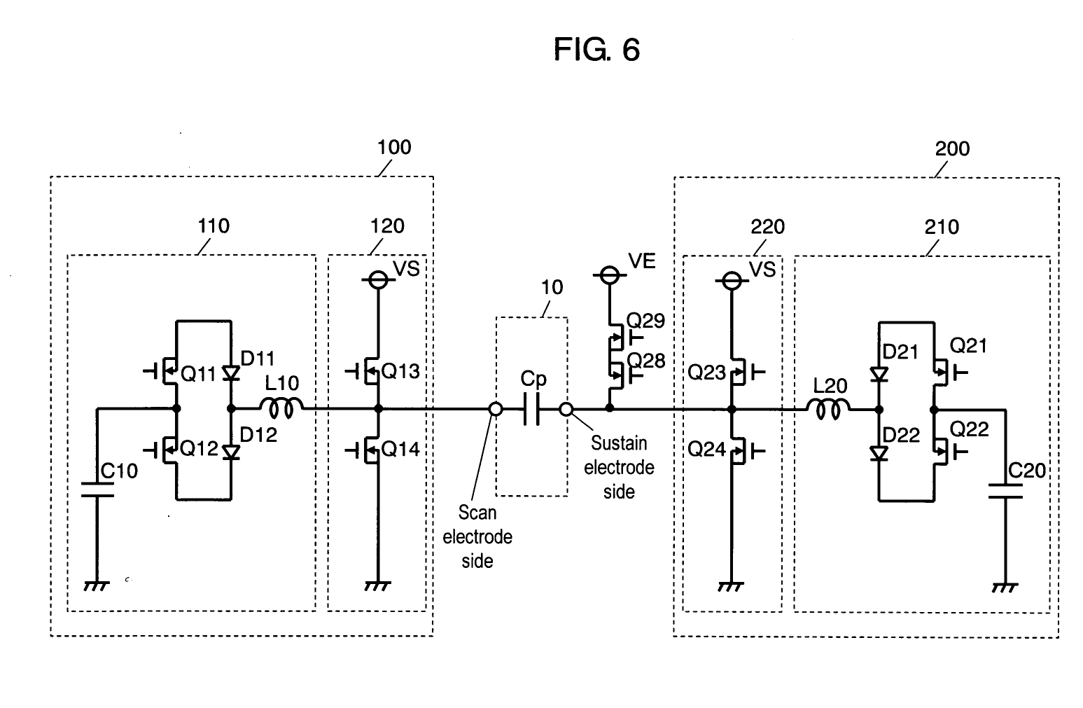

Next, the details of the operation in the sustain period are explained. First, the details of sustain pulse generating units 100, 200 which are the drive circuits for applying sustain pulses to each of the display electrode pair and carrying out sustain discharge of the discharge cells are explained. FIG. 6 is a circuit diagram of sustain pulse generating units 100 and 200 of the plasma display apparatus in the first embodiment of the present invention. Sustain pulse generating unit 100 is structured of electric power recovery unit 110 and clamp unit 120. Electric power recovery unit 110 has capacitor C10 for electric power recovery, switching elements Q11, Q12, diodes D11, D12 for prevention of backflow, and inductor L10 for electric power recovery. Clamp unit 120 has power supply VS whose voltage value is Vs, and switching elements Q13, Q14. And electric power recovery units 110 and clamp unit 120 are connected to scan electrode 22 which is one end of interelectrode capacitance Cp of panel 10 via the scanning pulse generating circuit. Meanwhile in FIG. 6, the scan pulse generating circuit is not illustrated. Capacitor C10 has capacity sufficiently larger than the interelectrode capacitance Cp, and the voltage value thereof is charged nearly Vs/2, and capacitor C10 works as a power source of electric power recovery unit 110.

Sustain pulse generating unit 200 is also of the same circuit structure as that of sustain pulse generating unit 100, is equipped with capacitor C20 for electric power recovery, switching elements Q21, Q22, diodes D21, D22 for prevention of backflow, and electric power recovery unit 210 including inductor L20 for electric power recovery, power source VS, clamp unit 220 including switching elements Q23, Q24, and the output of sustain pulse generating unit 200 is connected to sustain electrode 23 which is the other end of interelectrode capacitance Cp of panel 10. Meanwhile, power source VE for applying voltage Ve1 to sustain electrode 23, switching elements Q28, Q29 are also shown in FIG. 6 respectively for the explanation to be made later.

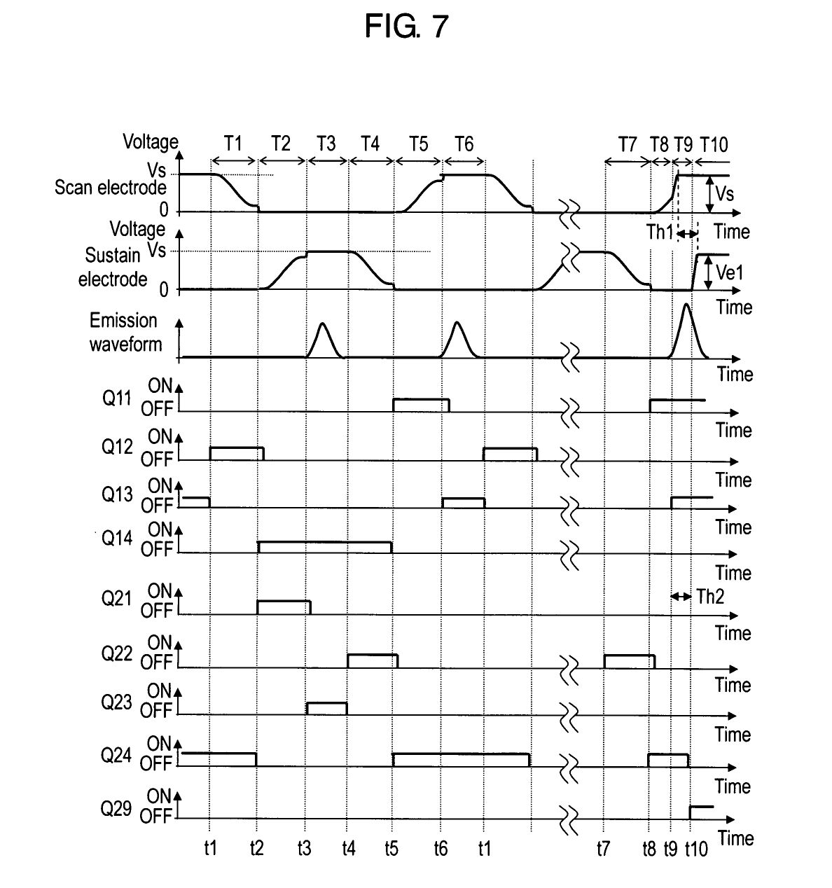

Next, the details of drive voltage waveforms are explained. FIG. 7 is a timing chart for explaining the operation of sustain pulse generating units 100, 200 of the plasma display apparatus in the first embodiment of the present invention, and is a timing chart with the detailed portion enclosed with the dashed line in FIG. 4. First, one cycle of the sustain pulse is divided into six periods shown by T1 to T6, and the respective periods are explained.

(Period T1) Switching element Q12 is turned ON at time t1. Then, the electric charge by the side of scan electrode 22 begin to flow into capacitor C10 through inductor L10, diode D12, and switching element Q12, and the voltage of scan electrode 22 begins to fall.

(Period T2) Since inductor L10 and interelectrode capacitance Cp form a resonant circuit, at time t2 after ½ of time progress of a resonance cycle, the voltage of scan electrode 22 falls down to around 0 V. However, the voltage of scan electrode 22 does not fall down to 0 V due to the electric power loss by the resistance components and the like of the resonant circuit. And switching element Q14 is turned ON at time t2. Then, since scan electrode 22 is directly grounded via switching element Q14, the voltage of scan electrode 22 falls to 0 V compulsorily.

Furthermore, switching element Q21 is turned ON at time t2. Then, current begins to flow from capacitor C20 for electric power recovery, via switching element Q21, diode D21, and inductor L20, and the voltage of sustain electrode 23 begins to go up. Meanwhile, in the present embodiment, the above resonance cycle is set approximately 1200 ns, and the time from time t1 to time t2, i.e., the time of period T1, is set 550 ns.

(Period T3) Since inductor L20 and interelectrode capacitance Cp form a resonant circuit, at time t3 after ½ of time progress of a resonance cycle, the voltage of sustain electrode 23 goes up to around Vs, but the voltage of sustain electrode 23 does not go up to Vs due to the electric power loss by the resistance components and the like of the resonant circuit. And switching element Q23 is turned ON at time t3. Then, since sustain electrode 23 is directly connected to power supply VS via switching element Q23, the voltage of sustain electrode 23 goes up to Vs compulsorily. Then, in the discharge cells which have caused write discharge, the voltage between scan electrode 22 to sustain electrode 23 exceeds the electric discharge starting voltage, and sustain discharge occurs.

In addition, switching element Q12 may be just turned off by time t5 after time t2, and switching element Q21 may be just turned off by time t4 after time t3. Moreover, in order to lower the output impedance of sustain pulse generating units 100, 200, it is preferable that switching element Q14 is turned off just before time t5, and switching element Q23 is turned off just before time t4.

(Period T4 to T6) Since the sustain pulse applied to scan electrode 22 and the sustain pulse applied to sustain electrode 23 are of the same waveform, since the operation from period T4 to period T6 is equal to the operation from period T1 to period T3 where scan electrode 22 and sustain electrode 23 are replaced, the explanation thereof is not given herein.

The above operation of periods T1 to T6 is repeated according to the required number of pulses. In addition, in the present embodiment, the time of periods T2, T4, and T5 is set 550 ns in the same manner as the time of period T1. Moreover, the time of periods T3 and T6 are set 1450 ns.

Next, the elimination electric discharge of the last of the sustain period is explained in detail.

(Period T7) This period is the one of falling of the sustain pulse applied to sustain electrode 23, and is same as period T4. That is, by turning ON switching element Q22 at time t7, the electric charge by the side of sustain electrode 23 begins to flow into capacitor C20 via inductor L20, diode D22, and switching element Q22, and the voltage of sustain electrode 23 begins to fall.

(Period T8) Switching element Q24 is turned on at time t8, and the voltage of sustain electrode 23 is compulsorily reduced to 0 V. And switching element Q11 is turned ON. Then, current begins to flow via switching element Q11, diode D11, and inductor L10 from capacitor C10 for electric power recovery, and the voltage of scan electrode 22 begins to go up.

(Period T9) Since inductor L10 and the interelectrode capacitance Cp form a resonant circuit, after ½ of time progress of the resonance cycle, the voltage of scan electrodes 22 goes up around Vs, but herein, switching element Q13 is turned ON at the period shorter than ½ of the cycle of resonance of the electric power recovery unit, i.e., at time t9 before the voltage of scan electrodes 22 goes up around Vs. Then, since scan electrode 22 is directly connected to power supply VS via switching element Q13, and the voltage of scan electrodes 22 rapidly goes up to Vs. Then, in the discharge cells which have caused write discharge, the voltage between scan electrode 22 to sustain electrodes 23 exceeds the electric discharge starting voltage, and sustain discharge occurs. Further, switching element Q24 is turned off just before time t10.

(Period T10) At time t10, switching element Q28 and switching element Q29 are turned ON. Then, since sustain electrode 23 is directly connected to power supply VE via switching elements Q28, Q29, the voltage of sustain electrode 23 goes up to Ve1 compulsorily. Time t10 is the time when the electric discharge generated at period T9 is completed, that is, the charged particles generated in electric discharge remain sufficiently in electric discharge space. And since the electric field in the electric discharge space changes while the charged particles remain enough in the electric discharge space, charged particles are rearranged and a wall electric charge is formed so that this changed electric field is eased. At this moment, since the difference of voltage Vs applied to scan electrode 22 and voltage Ve1 applied to sustain electrode 23 is small, the wall voltage on scan electrode 22 and sustain electrode 23 is weaken. Thus, the voltage difference which generates the last sustain discharge is the thin width pulse-shaped voltage difference changed so that the voltage difference given between the electrodes of the display electrode pair is eased before the last sustain discharge is completed, and the sustain discharge which occurs is elimination electric discharge. Moreover, data electrode 32 is held at 0 V at this moment, and since the charged particles by electric discharge form wall electric charge so that the voltage difference of the voltage applied to data electrode 32 and the voltage applied to scan electrode 22 is eased, on data electrode 32, positive wall voltage is formed.

Herein, elimination phase difference Th1 is the time interval from the time point after voltage Vs for generating elimination electric discharge is applied to scan electrode 22 to the time point, voltage Ve1 for easing the voltage difference between the electrodes of the display electrode pair is applied to sustain electrode 23. And the control thereof is performed by use of switching elements in the present embodiment. Namely, switching element Q13 which is the first switching element for applying voltage Vs for generating sustain discharge to scan electrode 22, and switching elements Q28, Q29 which are the second switching elements that apply voltage Ve1 for easing the voltage difference between the electrodes of the display electrode pair to the sustain electrode are arranged, and after switching element Q13 is turned ON, after the time interval according to the lighting rate of the discharge cells in the subfield (hereinafter referred to as “elimination phase difference Th2”), switching elements Q28, Q29 are turned ON. At this moment, although there is a possibility that elimination phase difference Th1 and elimination phase difference Th2 may not become strictly equal, as long as there is no large difference in the delay time and the like of switching elements, it may be considered that they are practically equal. Therefore, hereinafter, elimination phase difference Th1 and elimination phase difference Th2 are not distinguished, but they are described simply as elimination phase difference Th.

In addition, the time from time t9 to time t10, i.e., the time of period T9, is the elimination phase difference Th, and as shown in FIG. 5, it is controlled by the subfields and the lighting rate thereof. That is, in first SF to fourth SF, the elimination phase difference Th is controlled to become 150 ns irrespective of the lighting rate. And in fifth SF to the tenth SF, the elimination phase difference Th is controlled to become 150 ns when the lighting rate is less than 44%, and the elimination phase difference Th is controlled to become 200 ns when the lighting rate is not more than 44% and less than 70%, and the elimination phase difference Th is controlled to become 300 ns when the lighting rate is not less than 70%.

Thus, in the sustain period, after the voltage for generating the elimination electric discharge which is the last sustain discharge is applied to the display electrode pair, after the elimination phase difference Th which is the time interval according to the lighting rate of the discharge cells in the subfield, voltage is applied to the display electrode pair so that the voltage difference between the electrodes of the display electrode pair is eased. And the voltage difference to generate elimination electric discharge is the thin width pulse-shaped voltage difference which has changed the voltage difference given between the electrodes of the display electrode pair before the last sustain discharge is completed. Furthermore, in the present embodiment, as shown in FIG. 5, elimination phase difference Th is controlled so that elimination phase difference Th when the lighting rate of the discharge cells is high becomes longer than elimination phase difference Th when the lighting rate of the discharge cells is low, and elimination phase difference Th in the subfields where the brightness level is small is so controlled as to become equal to or shorter than elimination phase difference Th in the subfields where the brightness level is large. By the above control, it is possible to generate stable write discharge, without increasing scan pulse voltage and data pulse voltage.

Next, the reason why it is possible to generate stable write discharge, without increasing scan pulse voltage and data pulse voltage, by the driving method of the panel in the present embodiment is explained hereinafter.

As mentioned above, the elimination electric discharge by the thin width pulse changes the electric field in the electric discharge space while the charged particles generated in electric discharge remains sufficiently in the electric discharge space, and rearranges charged particles so as to ease this electric field and forms the wall electric charge, and thereby forms desired wall electric charge. Accordingly, when elimination phase difference Th becomes longer, the charged particles generated in electric discharge re-join together, and the charged particles for easing the electric field become insufficient, and it becomes impossible to form a desired wall electric charge. And as a result, it has been confirmed that a write fault where write discharge does not occur in the discharge cells which should be discharged (hereinafter referred to as “write fault of the first kind”) occurs frequently.

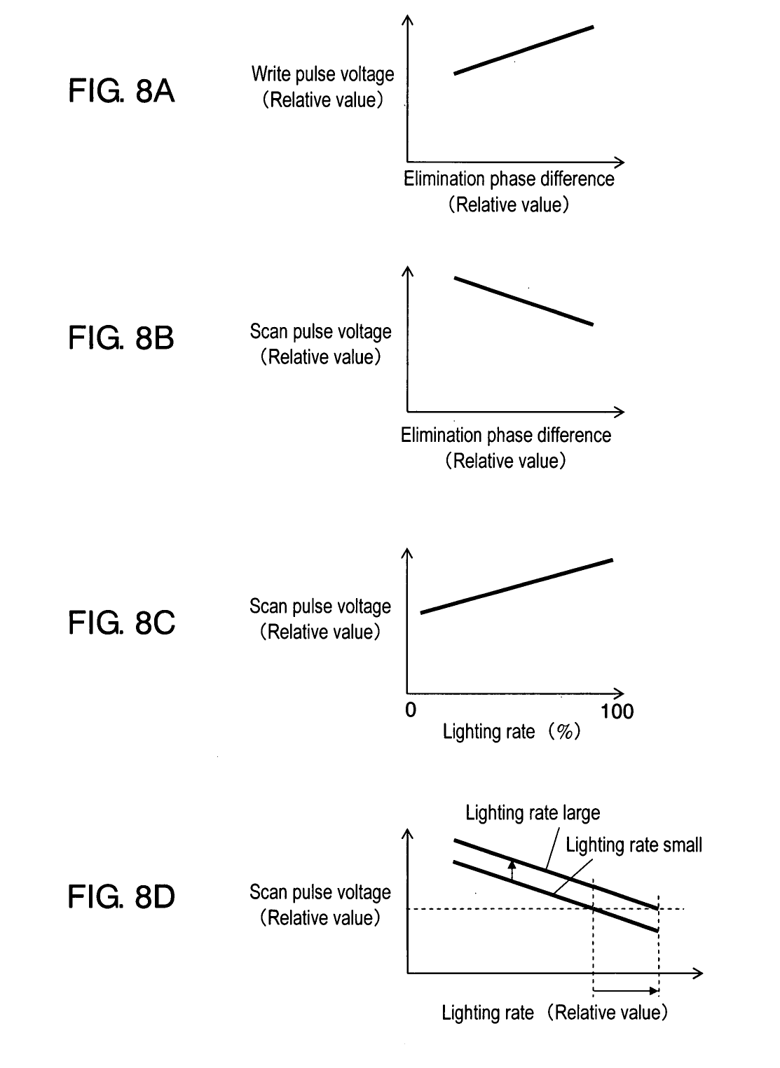

FIG. 8A is a schematic figure showing the relation between write pulse voltage required in order to generate normal write discharge and elimination phase difference Th, and the horizontal axis therein shows elimination phase difference Th, and the vertical axis thereof shows write pulse voltage required in order to generate the write discharge. As shown in this figure, it has been confirmed by experiment that as elimination phase difference Th becomes longer, the write pulse voltage required in order to generate write discharge precisely in the discharge cells which should be discharged becomes higher.

On the other hand, it has become clear by experiment that if elimination phase difference Th becomes too small, the scan pulse voltage required in order to generate normal write discharge becomes higher. The size of scan pulse voltage is the voltage for distinguishing the discharge cells of a selected line, and the discharge cells of the line which is not chosen. In practice, if this scan pulse voltage is actually made small, a write failure occurs where while write discharge is generated in the discharge cells of any line, the wall electric charge of the discharge cells of the line which is not chosen is removed, and the wall voltage is insufficient, and write discharge does not occur when write discharge should be generated originally (hereinafter referred to as “write failure of the second kind”).

FIG. 8B is a schematic figure showing the relation between the scan pulse voltage required in order to generate normal write discharge and elimination phase difference Th, and the horizontal axis shows elimination phase difference Th, and the vertical axis shows the scan pulse voltage required in order to generate normal write discharge. As shown in this drawing, it has become clear by experiment that as elimination phase difference Th becomes smaller, the scan pulse voltage required in order to generate such normal write discharge becomes higher. When the scan pulse voltage required in order to generate normal write discharge becomes higher, the write failure of the second kind mentioned above is likely to occur, and in order to prevent this, and it is required to make the scan pulse voltage high. Thus, the write failure of the first kind and the write failure of the second kind show the opposite characteristics to elimination phase difference Th, it has been found that it is practically preferable to set elimination phase difference Th to such a value as does not cause both of the write failures.

Furthermore, as a result of further detailed examinations, it also has become clear that this optimal elimination phase difference Th becomes longer as the lighting rate of the subfields becomes higher. FIG. 8C is a schematic figure showing the relation between the scan pulse voltage required in order to generate normal write discharge and the lighting rate, and the horizontal axis shows the lighting rate, and the vertical axis shows the scan pulse voltage required in order to generate normal write discharge. As shown in the figure, it has been found that when the lighting rate became higher, the scan pulse voltage required in order to generate normal write discharge becomes higher. Therefore, if has been found that when the scanning pulse voltage is constant, there is a tendency that the generation of electric discharge gets delayed. This may be supposed that when the lighting rate becomes higher, discharge current increases, and voltage decline accompanying that becomes larger and the effective voltage to be applied to the discharge cells decreases, and the scan pulse voltage required in order to generate normal write discharge becomes higher. Therefore, it may be considered that when the scan pulse voltage is constant, the effective voltage applied to discharge cells declines, and the generation of electric discharge gets delayed.

And, when electric discharge is delayed, it becomes the same electric discharge where the width of the thin width voltage difference to generate elimination electric discharge became narrow equivalently, namely, elimination phase difference Th becomes shorter. FIG. 8D is a schematic figure showing the relation between scan pulse voltage required in order to generate normal write discharge and elimination phase difference Th and the lighting rate. As shown in FIG. 8D, as the scan pulse voltage required in order to generate such normal write discharge becomes smaller, elimination phase difference Th becomes higher, and further, as lighting rate becomes higher, the scan pulse voltage required in order to generate normal write discharge becomes higher. Therefore, in the subfields where the lighting rate is high, optimal elimination phase difference Th becomes longer in compared with the subfields where the lighting rate is low.

As explained above, in the present embodiment, when the lighting rate is small, elimination phase difference Th is controlled to become the predetermined value, and as the lighting rate becomes larger, elimination phase difference Th is made longer, and the substantial thin width pulse width is made optimal. Thereby, it is possible to always maintain optimal elimination phase difference Th independently from the lighting rate, and perform the optimal drive.

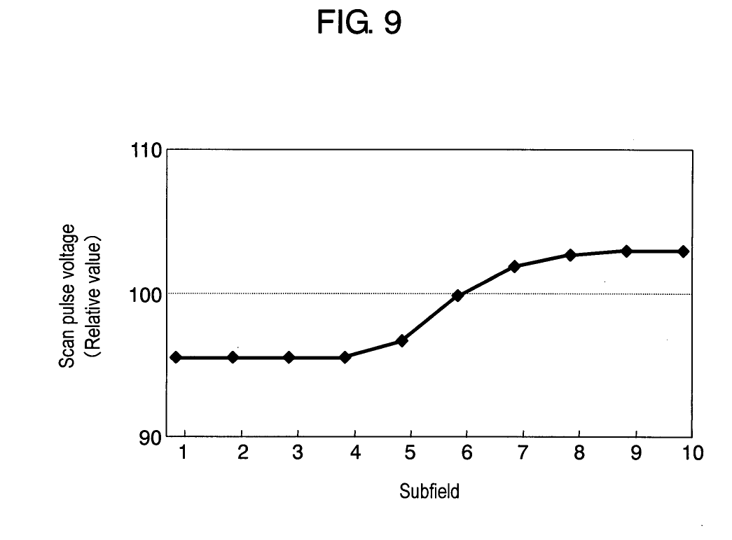

Moreover, in the present embodiment, in addition to the above, the control of elimination phase difference Th is changed per each subfield. FIG. 9 is a figure showing the lower limit of the scan pulse voltage at which the write failure of the second kind does not occur in the case when elimination phase difference Th in each subfield is set 150 ns. As mentioned above, when elimination phase difference Th is made smaller, the scan pulse voltage becomes higher, but it has been found that, as shown in FIG. 9, the brightness level of the subfield becomes larger, the degree becomes more conspicuous. This may be supposed that since priming sustain discharge increases in the subfields where brightness level is large, while write discharge is generated in the discharge cells of the selected line in the write period, the wall electric charge of the discharge cells of the line which is not chosen is likely to be removed, and the rate at which the wall voltage for write discharge decreases increases.

On the contrary, in the subfields where brightness level is small, the rate at which the wall voltage for write discharge decreases becomes smaller, and the scan pulse voltage can be set lower than that in the subfields where brightness level is large. Therefore, in the subfields where brightness level is small, even if the lighting rate becomes larger and the scan pulse voltage to prevent the write failure of the second kind goes up to some extent, unless required scan pulse voltage is exceeded in the subfields where brightness level is large, it is not necessary to perform the control according to the lighting rate.

As explained above, in the present embodiment, elimination phase difference Th in the subfields where brightness level is small is so controlled as to become equal to or shorter than elimination phase difference Th in the subfields where brightness level is large, and elimination phase difference Th when the lighting rate of discharge cells is high is so controlled as to become longer than elimination phase difference Th when the lighting rate of discharge cells is low. By such a control, it is realized to generate the stable write discharge without making higher the scan pulse voltage and the data pulse voltage.

Moreover, when elimination phase difference Th is changed, the light emission brightness accompanying elimination electric discharge also changes generally. Therefore, when elimination phase difference Th is changed frequently, there is a possibility that the brightness of display images may become unstable. However, in the present embodiment, by fixing elimination phase difference Th in the subfields where brightness level is small, the light emission brightness accompanying elimination electric discharge is made constant, and the fluctuation of brightness is prevented, and the image display quality is improved.

In addition, in the present embodiment, in the first SF to the fourth SF, irrespective of the lighting rate, elimination phase difference Th is so controlled as to be 150 ns, in the fifth SF to the tenth SF, when the lighting rate is less than 44%, elimination phase difference Th is so controlled as to be 150 ns, and when the lighting rate is not less than 44% and less than 70%, elimination phase difference Th is so controlled as to be 200 ns, and when the lighting rate is not less than 70%, elimination phase difference Th is so controlled as to be 300 ns, but the present invention is not limited to this, but it may be switched at a suitable lighting rate for each subfield. Moreover, the control may be so made that elimination phase difference Th changes substantially continuously according to the lighting rate. By controlling it in this manner, the influence which the change of elimination phase difference Th gives upon display images also continuously changes, and the image display quality is also improved.

In addition, hysteresis characteristics may be arranged in switching elimination phase difference Th. Hereinafter, such an embodiment is explained.

### Second Embodiment

Since the structure of a panel in the present embodiment is the same as in the first embodiment, the explanation thereof is not given herein. Moreover, although the circuit block of a plasma display apparatus is also same as that in FIG. 3, the lighting rate calculation circuit 58 compares the lighting rate between the subfields which have the same brightness level, in the present field and the previous field. And the timing generating circuit 55 controls the timing signal to be supplied to the sustain electrode drive circuit 54 on the basis of the comparison result in the lighting rate calculation circuit 58 and the detected lighting rate.

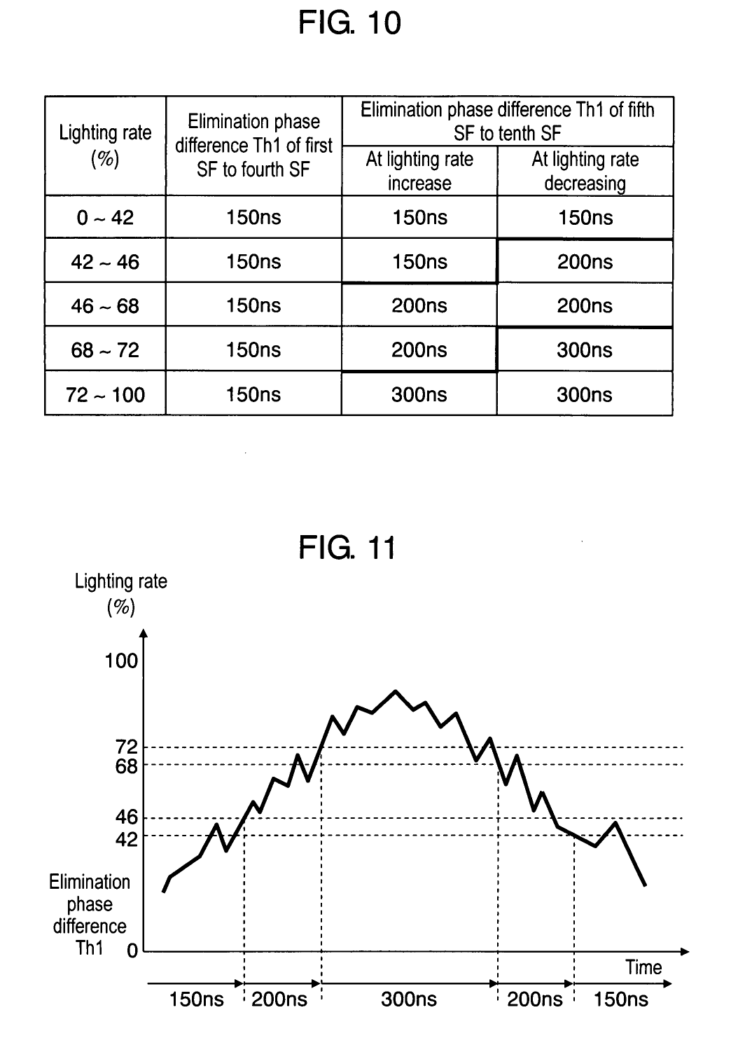

FIG. 10 is a figure showing the relation of the subfields and the lighting rate and elimination phase difference Th1 in the second embodiment according to the present invention. In the first SF to the fourth SF, irrespective of the lighting rate, elimination phase difference Th1 is so controlled as to become 150 ns. On the other hand, in the fifth SF to the tenth SF, elimination phase difference Th1 is switched according to the lighting rate. Thus, by switching elimination phase difference Th1 on the basis of the lighting rate, it is possible to generate the stable write discharge, without making higher the scan pulse voltage and the data pulse voltage. Moreover, in the present embodiment, the lighting rates of the subfields which has the same brightness level in the previous field and the present field are compared, and the value of the lighting rate used as the threshold value at the time of switching elimination phase difference Th1 is changed according to the case where the lighting rate is increasing and the case where the lighting rate is decreasing. Thereby, hysteresis characteristics are arranged to the switching of elimination phase difference Th1.

Namely, elimination phase difference Th1 is so controlled as to become 150 nsec at the lighting rate less than 46%, 200 nsec at the lighting rate not less than 46% and less than 72%, and 300 nsec at the lighting rate not less than 72% when the lighting rate is increasing, and further, it is so controlled as to become 150 nsec at the lighting rate less than 42%, 200 nsec at the lighting rate not less than 42% and less than 68%, and 300 nsec at the lighting rate not less than 68% when the lighting rate is decreasing.

FIG. 11 is a figure showing the relation of the lighting rate and elimination phase difference Th1 in the second embodiment of the present invention, and the horizontal axis shows time and the vertical axis shows the lighting rate. In addition, as mentioned above, in the present embodiment, in the fifth SF to the tenth SF, the lighting rates of the subfields which have the same brightness level in the previous field and the present field are compared, and it is judged whether the lighting rate is decreasing, or the lighting rate is increasing. Therefore, in FIG. 11, the relation of the lighting rate and elimination phase difference Th1 in the fifth SF is shown as an example, and the time of the horizontal axis shows the data of only the fifth SF extracted in respective fields, and the lighting rate of the vertical axis shows the lighting rate in the fifth SF. And, it is supposed that also in the sixth SF to the tenth SF, the same operation as in the case of the fifth SF shown in FIG. 6 is carried out.

As shown in FIG. 11, the lighting rate to become the threshold value at the moment of switching elimination phase difference Th1 becomes 46% and 72%, while the lighting rate is increasing, i.e., at the moment of the right-up waveform in the figure, meanwhile, it becomes 42% and 68% when the lighting rate is decreasing, i.e., at the moment of the right-down waveform in the figure. Accordingly, while the lighting rate is increasing, elimination phase difference Th1 switches from 150 nsec to 200 nsec at the moment when the lighting rate of the fifth SF reaches 46%, and further, it switches from 200 nsec to 300 nsec when a lighting rate reaches 72%. Moreover, while the lighting rate is decreasing, it switches from 300 nsec to 200 nsec at the moment when the lighting rate of the fifth SF is less than 68%, and further, it switches from 200 nsec to 150 nsec at the moment when the lighting rate is less than 42%. Namely, in elimination phase difference Th1, when the first time interval is set for example 150 nsec and the second time interval is set 200 nsec, the threshold value at the moment of switching from 150 nsec which is the first time interval to 200 nsec which is the second time interval longer than that is 46%, which is larger than the threshold value 42% which is the threshold value at the moment of switching from 200 nsec which is the second time interval to 150 nsec which is the first time interval. Moreover, if the first time interval is set for example to 200 nsec, and the second time interval is set to 300 nsec, the threshold value at the moment of switching from 200 nsec which is the first time interval to 300 ns which is the second time interval longer than that is 72%, and it is a larger value than the threshold value 68% at the moment of switching from 300 nsec which is the second time interval to 200 nsec which is the first time interval.

Thus, in the present embodiment, by switching elimination phase difference Th1 on the basis of the lighting rate, it is possible to generate the stable write discharge, without making higher the scan pulse voltage and the data pulse voltage. Furthermore, in the present embodiment, by changing the value of the lighting rate to become the threshold value at the time of switching elimination phase difference Th1 on the basis of whether the lighting rate is increasing or decreasing, hysteresis characteristics are given to the switching of elimination phase difference Th1. Thereby, elimination phase difference Th1 is prevented from switching frequently by minute changes of the lighting rate around the threshold value.

The operation in the sustain period is nearly same as the operation explained in the first embodiment with reference to FIG. 6 and FIG. 7. However, what is difference from the first embodiment is that, as shown in FIG. 10, FIG. 11, the control is made on whether the subfield and the lighting rate of the subfield, and, the lighting rate of the subfields which have the same brightness weight level in the previous field and the present field are increasing or decreasing. That is, in the first SF to the fourth SF, irrespective of the lighting rate, elimination phase difference Th is so controlled as to become 150 ns. Moreover, elimination phase difference Th1 in fifth SF to the tenth SF compares the lighting rates of the subfields which have the same brightness level in the previous field and the present field, and when the lighting rate is increasing, it is so controlled as to become 150 nsec at the lighting rate less than 46%, 200 nsec at the lighting rate not less than 46% and less than 72%, and 300 nsec at the lighting rate not less than 72%, and when the lighting rate is decreasing, it is so controlled as to become 150 nsec at the lighting rate less than 42%, 200 nsec at the lighting rate not less than 42% and less than 68%, and 300 nsec at the lighting rate not less than 68%, and when the lighting rate is decreasing.

Thus, in the sustain period, after the voltage for generating the elimination electric discharge which is the last sustain discharge to the display electrode pair, elimination phase difference Th which is the time interval according to the lighting rate of the discharge cells in the subfield is arranged, and the voltage is applied to the display electrode pair so as to ease the voltage difference between the electrodes of the display electrode pair. And the voltage difference which generates the elimination electric discharge is the thin width pulse-shaped voltage difference changed from the voltage difference to be given between the electrodes of the display electrode pair before the last sustain discharge is completed.

Furthermore, in the present embodiment, as shown in FIG. 10, FIG. 11, elimination phase difference Th is so controlled as to become equal to or shorter than elimination phase difference Th in the subfields where the brightness level is large, and elimination phase difference Th when the lighting rate of the discharge cells is high is so controlled as to become longer than elimination phase difference Th when the lighting rate of the discharge cells is low. By the above control, it is possible to generate stable write discharge, without making higher the scan pulse voltage and data pulse voltage.

Moreover, in the present embodiment, hysteresis characteristics are given to the switching of elimination phase difference Th1 by changing the value of the lighting rate to become the threshold value at the moment of switching elimination phase difference Th1 in the case where the lighting rate is decreasing and in the case where the lighting rate is increasing. Thereby, elimination phase difference Th1 is prevented from changing frequently due to minute changes of the lighting rate around the threshold value.

As explained above, in the present embodiment, elimination phase difference Th in the subfields where the brightness level is small is so controlled as to become equal to or shorter than elimination phase difference Th in the subfields where the brightness level is large, and elimination phase difference Th when the lighting rate of discharge cells is high is so controlled as to become longer than elimination phase difference Th when the lighting rate of discharge cells is low. Through such a control, it is possible to generate the stable write discharge, without making higher the scan pulse voltage and the data pulse voltage.

Further, when elimination phase difference Th is changed, the luminescence light emission brightness accompanying elimination electric discharge also changes generally, and there is a possibility that the brightness of display images may become unstable. Therefore, in the present embodiment, elimination phase difference Th is fixed in the subfields where the brightness level is small, and thereby the light emission brightness accompanying elimination electric discharge is made constant, and the fluctuation of brightness is prevented, and the image display quality is improved.

Furthermore, in the present embodiment, as mentioned above, hysteresis characteristics are given to the switching of elimination phase difference Th1 by changing the value of the lighting rate to be come the threshold value at the moment of switching elimination phase difference Th1 in the case where the lighting rate is decreasing and in the case where the lighting rate is increasing. Thereby, elimination phase difference Th1 is prevented from changing frequently due to minute changes of the lighting rate around the threshold value, and the further quality display images are realized.

Meanwhile, the values of the time of the respective periods T1 to T10 illustrated in the present embodiment are just examples, and the present invention is not limited to these, but it is preferable to set the values according to the electric discharge characteristics of the panel and the like.

In addition, in the present embodiment, elimination phase difference Th is so controlled as to become 150 ns irrespective of the lighting rate in the first SF to the fourth SF, and in fifth SF to the tenth SF, while the lighting rate is increasing, at the moment when the lighting rate reaches 46%, it is so controlled as to change from 150 nsec to 200 nsec, and at the moment when the lighting rate reaches 72%, it is so controlled as to change from 200 nsec to 300 nsec, and while the lighting rate is decreasing, it is changed from 300 nsec to 200 nsec at the moment when the lighting rate goes below 68%, and it is so controlled as to change from 200 nsec to 150 nsec at the moment when the lighting rate goes below 42%, however, the present invention is not limited to this, but it may be switched at a suitable lighting rate for each subfield. Moreover, control may be made so that elimination phase difference Th substantially changes continuously according to the lighting rate. By performing such a control, the influence which changes of elimination phase difference Th give upon display images also changes continuously, and accordingly, the image display quality is also improved.

In addition, the values of the time of the respective periods T1 to T10 illustrated in the first and second present embodiments are just examples, and the present invention is not limited to these, but it is preferable to set the values according to the electric discharge characteristics of the panel and the like.

Furthermore, in the first and second present embodiments, it has been explained that the entire cell initialization operation is performed during in the initialization period of the first SF, and in the initialization period of the second SF, the selective initialization operation is performed, however, the present invention is not limited to this, but the entire cell initialization operation and the selective initialization operation may be performed optionally in the respective subfields.

Moreover, in the first and second embodiments, one field is divided into ten subfields (first SF, second SF, . . . , the tenth SF) and each subfield has brightness levels (1 2, 3, 6, 11, 18, 30, 44, 60, 81) respectively, however, in the present invention, the number of the subfields, or the brightness levels of each subfield are not limited to the above values.

According to the present invention, it is possible to provide a method for driving a panel and a plasma display apparatus for generating stable write discharges for high image display quality, without increasing voltage necessary for generating the write discharges, even with a large size and high brightness panel.

### INDUSTRIAL APPLICABILITY

The method for driving a panel according to the present invention is for enabling write operation at low write pulse voltage, even with a large size and high brightness panel, and it is useful when applied to a plasma display apparatus using a panel and the like.

1. A method for driving a plasma display panel equipped with a plurality of discharge cells having display electrode pairs including scan electrodes and sustain electrodes, wherein
one field period is structured of a plurality of subfields having a write period for generating write discharges selectively in the discharge cells, and a sustain period for generating the number of times of sustain discharges according to brightness levels in the discharge cells which have generated the write discharges, and
in the sustain period, after voltage to generate the last sustain discharge is applied to the display electrode pairs, at time intervals according to the lighting rate of the discharge cells in the subfield, voltage to ease the voltage difference between the electrodes of the display electrode pairs is applied to the display electrode pairs.

2. A method for driving a plasma display panel according to claim 1, wherein at least one subfield that is so controlled that the time interval when the lighting rate of discharge cells is high should be longer the time interval when the lighting rate of discharge cells is low is included in one field period.

3. A method for driving a plasma display panel according to claim 1, wherein the time interval in the subfields whose brightness level is small is so controlled as to become equal or shorter than the time interval in the subfields whose brightness level is large.

4. A plasma display apparatus comprising:
a plasma display panel which is equipped with plurality of discharge cells having a display electrode pair structured of a scan electrodes and a sustain electrode, and
a drive circuit which drives the panel, wherein
the drive circuit structures one field period of a plurality of subfields having a write period for generating write discharges selectively in the discharge cells and a sustain period for generating the number of times of sustain discharges according to brightness levels in the discharge cells which have generated the write discharges, and is equipped with a first switching element which applies the voltage for generating the sustain discharge to the display electrode pair, and a second switching element which applies the voltage for easing the voltage difference between the electrodes of the display electrode pair to the display electrode pair, and
in generating the last sustain discharge in the sustain period, turns on the first switching element, then after time intervals according to the lighting rate of the discharge cells in the subfield, turns on the second switching element.

5. A plasma display apparatus according to claim 4 further comprising,
a lighting rate calculation circuit for computing the lighting rate of the discharge cells for each subfield on the basis of the image data for each subfield, and
wherein the drive circuit is so structured that at least one subfield that is so controlled that the time interval when the lighting rate of discharge cells is high should be longer the time interval when the lighting rate of discharge cells is low is included in one field period.

6. A plasma display apparatus according to claim 4, wherein the time interval in the subfields whose brightness level is small is so controlled as to become equal to or shorter than the time interval in the subfields whose brightness level is large.

7. A plasma display apparatus according to claim 1, wherein the time interval is switched on the basis of the comparison of the lighting rate of the discharge cells in the current subfield and a predetermined threshold value, and the threshold value at switching from a first time interval to a second time interval is set larger than the threshold value at switching from the second time interval to the first time interval.

8. A method for driving a plasma display panel according to claim 2, wherein the time interval in the subfields whose brightness level is small is so controlled as to become equal or shorter than the time interval in the subfields whose brightness level is large.

9. A plasma display apparatus according to claim 5, wherein the time interval in the subfields whose brightness level is small is so controlled as to become equal to or shorter than the time interval in the subfields whose brightness level is large.
